(19) United States
(12) Patent Application Publication
(10) Pub. No.: US 2005/0171837 A1
(43) Pub. Date: Aug. 4, 2005

(54) Interactively create uniquely Identified Tangible Print Advertising from Internet Web Pages

(76) Inventor: Charles Eglinton, Farmington Hills, MI (US)

Correspondence Address: JEFFREY FURR, 253 N. MAIN STREET, JOHNSTOWN, OH, 43031, US

(21) Appl. No.: 10/708,028

(22) Filed: Feb. 3, 2004

(51) Int. Cl. G06F 17/60

(52) U.S. Cl. 705/14

(57) ABSTRACT

The current invention is a method for bridging the gap between the virtual multimedia-based Internet world and the physical world of tangible object media, such as print advertising. More particularly, a method for multimedia-based Internet Advertisers to expand the promotion of their products and web pages by encouraging Affiliates to post uniquely identified printed versions of the virtual advertising to be posted or otherwise physically distributed in the tangible world.

### BACKGROUND OF INVENTION

1. Field of the Invention

This invention relates to the art of printing advertising from Internet Web Pages and more specifically the use of unique identifiers for this purpose.

2. Description of Prior Art

More and more commerce is moving to the Internet. This movement creates opportunities and problems. The Internet is a great tool for visual information and advertising but this advertising is not set up to be in a printed format.

The World Wide Web is currently a subject of intense and rapidly growing interest. The World Wide Web is composed of interconnected data sources that are accessible to computer users through data-communication networks such as the Internet. The data available on the World Wide Web has been assembled by private individuals, commercial companies, government agencies, and special interest organizations. Much of this assembled information is organized into Web pages. A Web site is a collection of Web pages (and possibly other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to users of the World Wide Web through a software program known as a Web server. A network user uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java bytecode), and other content to be downloaded to the client computer or displayable through client software programs that add to the browser's functionality (sometimes referred to as “browser plug-ins”).

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

With the rapid growth of computer networking and requests for information from one computer to the next e.g. the Internet, it has become common practice for a provider of information (a “Server”) to provide each specific requester of information (a “Client”), with an electronic “token” (commonly referred to as a “Cookie”) for the purpose of “recognizing” the client and/or providing some pre-determined and pre-programmed level of customization at the discretion of the information provider.

Prior Art

U.S. Pat. No. 6,457,005 by Torrey and issued on Sep. 24, 2002 is for a “Method and system for referral management.” It discloses the solicitation and management of referrals facilitated by methods that record in a database the descriptions of opportunities and the terms under which referral fees will be paid to parties that refer resources for consideration. U.S. Pat. No. 6,314,404 by Good, et al. and issued on Nov. 6, 2001 is for a “Method and apparatus for managing real estate brokerage referrals.” It discloses a method for managing real estate brokerage referrals in which the referrals are made by a broker for residential real estate. U.S. Pat. No. 6,029,141 by Bezos, et al. and issued on Feb. 22, 2000 is for an “Internet-based customer referral system.” It discloses an Internet-based referral system that enables individuals and other business entities (“associates”) to market products, in return for a commission, that are sold from a merchant's Web site. U.S. Pat. No. 6,546,418 by Schena, et al. and issued on Apr. 8, 2003 is for a “Method for managing printed medium activated revenue sharing domain name system schemas.” It discloses a method for bridging the gap between the virtual multimedia-based Internet world and the physical world of tangible object media, such as print media.

U.S. Pat. No. 6,334,111 by Carrott and issued on Dec. 25, 2001 is for a “Method for allocating commissions over the internet using tags.” It discloses a method and structure for allocating commissions for sales made over the Internet including providing a link to a merchant site, attaching a tag to potential customers who select the link (where the tag identifies an association between the potential customers and a salesperson who provided the link), and allocating the commissions for purchases made by the potential customers based upon the tag. U.S. Pat. No. 5,537,314 by Kanter and issued on Jul. 16, 1996 is for a “Referral recognition system for an incentive award program.” It discloses a credit accumulation and accessing system for a plurality of sponsoring companies and participants having at each sponsoring company location a common bus, which communicates with participant data input, performance data input, computer processing, memory, an award output device, and an input/output device.

These systems and prior patents do not disclose and use print media from the websites to track referrals.

The need for a better method for the printing and tracking of advertisement from the Internet, that is faster, inexpensive, and easy to use shows that there is still room for improvement within the art.

### SUMMARY OF INVENTION

The object of the present invention is to provide a merger of Internet and Print Medium.

The current invention is a method for bridging the gap between the virtual multimedia-based Internet world and the physical world of tangible object media, such as print advertising. More particularly, a method for multimedia-based Internet Advertisers to expand the promotion of their products and web pages by encouraging Affiliates to post uniquely identified printed versions of the virtual advertising to be posted or otherwise physically distributed in the tangible world.

The types of tangible media covered by the current invention would include but not be limited to printed page, posters, business cards, banners, and other printed media.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The process is more efficient, effective, accurate and functional than the current art.

Glossary of Terms

Affiliate/Client: person or business who markets the Advertiser″s products in return for monetary payment, product credit or discounts, or other compensation Advertiser/Publisher: person or business with the items or products to sell.

Advertiser Media: includes the web page or other prospective Internet based information that is distributed by the Advertiser via modem, and ultimately printed and distributed by the Affiliate.

Browser: a software program that runs on a client host and is used to request Web pages and other data from server hosts. This data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Clip: a video stream that contains images and possible sound.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Logfile: a file residing on the Web site in which the Web server logs information about browsers requesting Web components. The logfile typically contains one line per hit.

Offline Affiliate Clearinghouse: the service at which accounts are settled. An Advertiser makes payment to clearinghouse and the Affiliate receives payment from the clearinghouse. Any or all of the participants in the service may pay fees to the clearinghouse. Accounts are settled by the clearinghouse and where the Advertisers make payment and where the Affiliate proposed services to make any web site into print-ready flyer, poster, or other printable advertising media. The service will use a method to place a Unique Identifier Code for each enrolled Advertiser/Publisher or product for each enrolled web page.

Unique Identifier Code: an alphanumeric code that identifies the Affiliate/Client, the Advertiser/Publisher, the particular offer, or any other information related to the relationship of these.

Pageview: the event of a browser downloading some or all of the Web components that make up a Web page and displaying the Web page. A pageview often consists of several hits.

Referral page: the URL of the Web page containing the HyperText link that led a visitor to the data currently being viewed. In most commercial browsers, the BACK button returns the visitor to this referral page.

Server host: a computer on the Internet that hands out Web pages through a Web server program.

Tangible Media: Includes media that can be seen and held in the tangible world. For example, tangible media includes printed pages of all sizes including flyers, posters, coupons and business cards.

Uploader: someone who wants to upload a video clip or image.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Viewer: someone who wants to view the video image or clip.

“virtualFlyer or virtualPoster: a web page or graphic download that was created on demand which contains a unique Identifier code that Identifies the Sub-Affiliate and or Affiliate that will be entitled to compensation or other consideration. Affiliate or Sub-affiliate will print the virtual poster to create tangible print media. The Unique Identifier Code label may but is limited to, “discount code” or “Special Offer Code” Visit: a series of requests to a fixed Web server by a single person (through a browser), occurring contiguously in time.

Visitor: a person operating a browser and, through it, visiting a Web site.

Web component: a basic data building block that makes up a Web page. A Web component may contain text, HyperText, images, embedded client software programs, or other data displayable by a browser (such as, for example, QuickTime videos).

Web designer: a person, typically one skilled in graphical design, who has charge of designing Web pages.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2 shows the user accessing a rental web page;

FIG. 3 shows a printed screen and tabs printed from a website;

FIG. 4 displays a tab with the Unique Identifier;

FIG. 5 displays a card print screen;

FIG. 6 displays a card print with the Unique Identifier; and

FIG. 7 displays a flowchart of the process.

### DETAILED DESCRIPTION

The current invention is a system and method for providing a merger of Internet and Print Medium.

The current invention is a method for bridging the gap between the virtual multimedia-based Internet world and the physical world of tangible object media, such as print advertising. More particularly, a method for multimedia-based Internet Advertisers to expand the promotion of their products and web pages by encouraging Affiliates to distribute identified printed versions of the virtual advertising to be posted or otherwise physically distributed in the tangible world.

The types of tangible media covered by the current invention would include but not be limited to printed page, posters, business cards, banners, coupons and other printed media.

The current invention is an internet-based customer referral system software to interactively create, distribute, and uniquely Identified Tangible Print Advertising from Internet Web Pages and to track the activity of affiliates, sub-affiliates and customers The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then receive the file containing the Uniquely Identified print media or display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

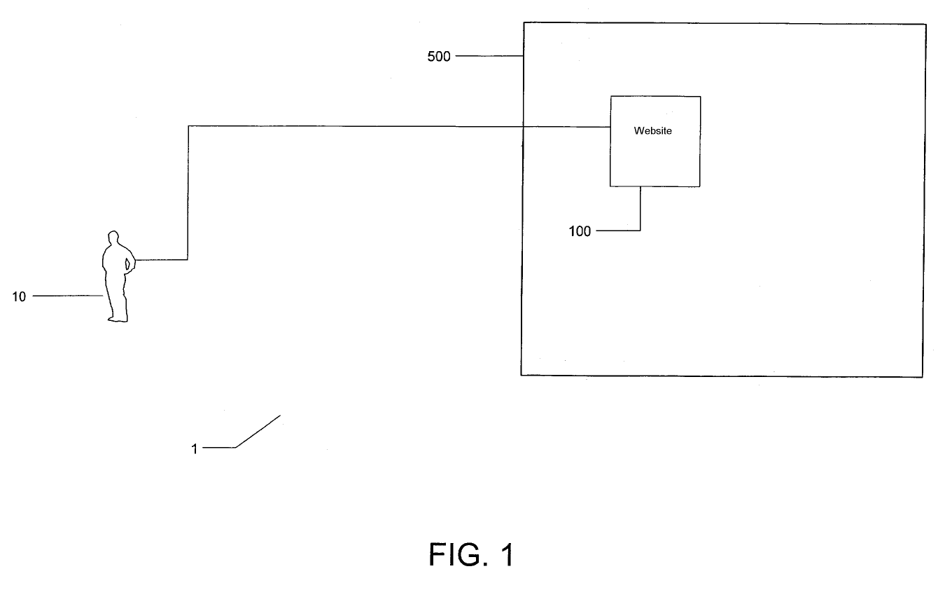

FIG. 1 illustrates a functional diagram of a computer network for World Wide Web access to the system 1 from a plurality of customer/Users 10 to the web site 100. Accessing the web site 100 can be accomplished directly through a communication means such as a local Internet Service Provider, often referred to as ISPs, or through an on-line service provider like CompuServe, Prodigy, American Online, etc.

The Users 10 contact the web site 100 using an informational processing system capable of running an HTML compliant Web browser such as Microsoft's Internet Explorer, Netscape Navigator, Lynx and Mosaic. A typical system that is used is a personal computer with an operating system such as Windows 95, 98, 2000, XP or ME or Linus, running a Web browser. The exact hardware configuration of computer used by the Users 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

Advertiser Media includes the web page or other prospective Internet based information that is distributed by the Advertiser via modem or other connection means such as cable or a T1 line, and ultimately printed and distributed by the Affiliate. An Affiliate or Client is the person or business who markets the Advertiser″s products.

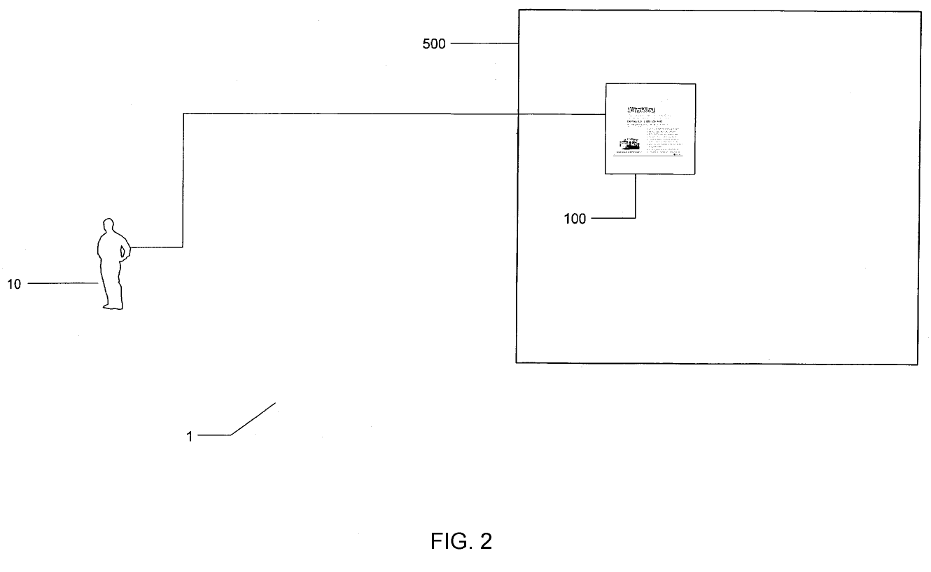

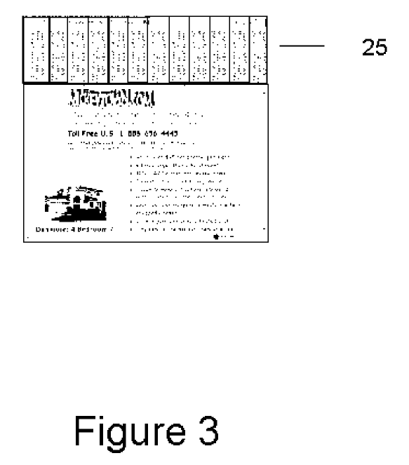

As shown in FIG. 2, the Users 10 connects to a Web site 100 that promotes rental vacation property. This web site would have some type of advisement or information that would interest the User 10. When the user selects the property that interested them they will print out the selected property. This will result in a tangible print media delivery. This will result in a tangible print media delivery. As shown in FIG. 3, this can be in the form of tabs 25 which can be separated by scissors but remain attached to the tangible print media.

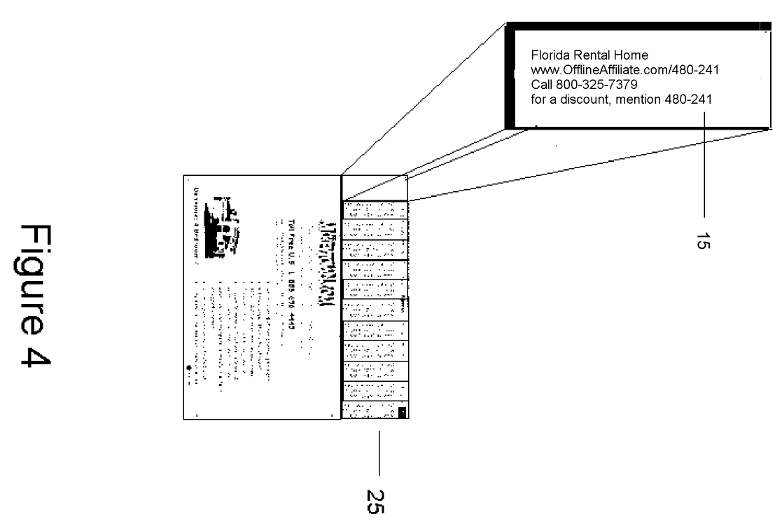

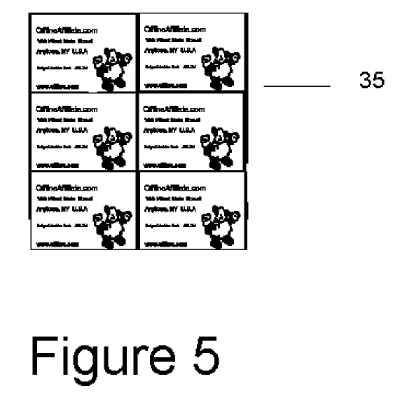

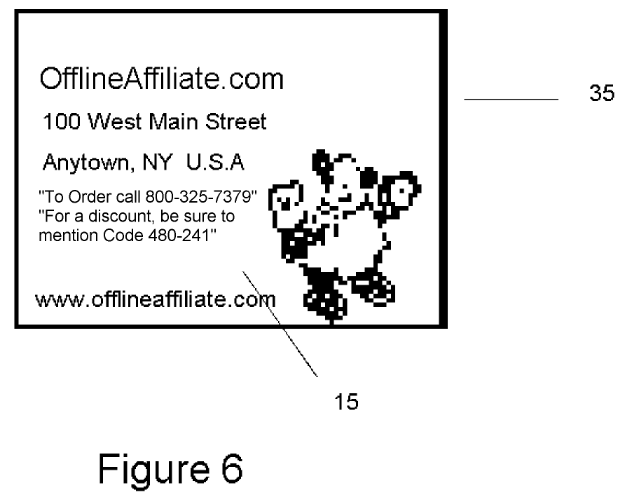

The tangible print media is created by the system” s 1 software. The Tangible Print Media consists of Advertiser″s Print Media dynamically merged with a code 15 or other information that will identify the Affiliate who will place the advertising print media in the tangible world as shown in FIG. 4. Media types include: Uniquely Identified Business Cards 35; Uniquely Identified Flyers and Uniquely Identified Posters of any size. Business cards 35 are displayed in FIG. 5 with a detailed view of the unique identifier code 15 in FIG. 6. The user 10 can then print out the tangible print media using any type of printing means such as a laser or inkjet printer that is attached to their computer or a LAN or network.

The Unique Identifier Code 15 is generated by on-line and/or offline software to combine Advertiser information and Coded Affiliate information to create uniquely identified advertising media that is delivered to the Affiliate electronically. This software is loaded on a memory means such as a hard drive or RAM.

The system 1 maintains multiple online databases including Advertiser and Affiliate contact information, commission offers, and commission account reconciliation. The system 1 educates Advertisers and Affiliates regarding successful advertising campaigns using tangible printed advertisement delivered electronically, printed and placed by Affiliates.

In the preferred embodiment, the methods of delivering uniquely identified print advertising are not limited to just a printer, and can include, but are not limited to, Internet Browser, electronic mail, electronic file transfer, traditional mail, and other tangible and electronic methods of delivery. Advertiser fulfills order and/or contacts prospective customer as a result of Tangible Print Advertising. The modification of the media to produce the uniquely identified print advertising associate information is accomplished by having print media offered by the advertiser modified automatically by using Perl, ASP, Javascript or another computer programming language at the moment the media is displayed on the user″s computer.

In alternative embodiments, the modification can be done by having the print media offered by the advertiser be modified manually. This includes, but is not limited to, the modification of merchant information using a software-editing program. The prospective tangible print media may also be modified by using overlays that replace designated or undesignated information that is displayed on the merchant″s web page.

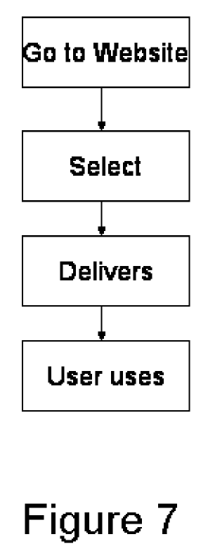

As shown in FIG. 7, the system 1 works in the following manner: The User 10 goes to a particular web site 100 in the Internet 500. After selecting what the User 10 is interested in the User 10 selects the Tangible Print Media option. The system delivers the tangible print media in the User″s 10 desired format. The user 10 uses the tangible print media.

Uniquely Identified Business Cards are created by system 1 software that dynamically creates perfectly formatted business cards that are displayed on the User″s 10 computer browser or otherwise sent to the User 10. The web site 100 may print then distribute the uniquely identified business cards.

Uniquely Identified Tabbed Flyers are created by system 1 software that dynamically creates tabbed flyers from preexisting Internet Web Pages. The system 1 uses existing browser frames ability with proprietary methods of creating graphical text to create uniquely identified tabbed advertising media. The User 10 may print then distribute or conspicuously post the uniquely identified tabbed business flyers. The User 10 or prospective customers can remove the paper tabs 25 from the top of the flyers to retain contact information for the Advertiser 130.

Although the present invention has been described in considerable detail with reference to certain preferred versions thereof, other versions are possible. For example, the web site could use a different or new protocol to communicate or an Intranet could be used. Therefore, the point and scope of the appended claims should not be limited to the description of the preferred versions contained herein.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An internet-based system for an advertising comprising: having a user connect to a website; having said user select a webpage; and allowing virtual advertising to be delivered to said user.

2. A system according to claim 1 which includes having said advertising being printed through a printing means.

3. A system according to claim 1 which includes having said advertising being tangible print media.

4. A system according to claim 4 which includes having said advertising dynamically merged with a code that will identify who placed the advertisement.

5. A system according to claim 1 which includes having said user contact the system through the Internet.

6. A system according to claim 1 which includes having said user connect to the system through the use of a computer.

7. A system according to claim 1 which includes having said user connect to the system through the use of a computer through the Internet.

8. A system according to claim 1 which includes having said advertisement being tabbed flyers.

9. A system according to claim 5 which includes having said advertisement being uniquely identified tabbed flyers

10. A system according to claim 1 which includes having said advertisement being business cards.

11. A system according to claim 5 which includes having said advertisement being uniquely identified business cards.

12. A system according to claim 1 which includes having said advertisement being posters.

13. A system according to claim 5 which includes having said advertisement being uniquely identified posters.

14. A system according to claim 1 which includes allowing said user to choose the method of postage.

15. A system according to claim 1 which includes having said advertising being delivered through electronic mail.

16. A system according to claim 1 which includes having said advertising being delivered through a telephone system.

17. An Internet-based system for an advertising comprising: having a user connect to a website; having said user select a webpage; allowing virtual advertising to be delivered to said user; having said advertising being printed through a printing means; having said advertising being tangible print media; and having said advertising dynamically merged with a code that will identify who placed the advertisement.

18. A system according to claim 17 which includes having said user contact the system through the Internet.

19. A system according to claim 17 which includes having said user connect to the system through the use of a computer.

20. A system according to claim 17 which includes having said advertisement being uniquely identified.
